(19) United States
(12) Patent Application Publication
(10) Pub. No.: US 2016/0302031 A1
(43) Pub. Date: Oct. 13, 2016

(54) Smartphone Application for Online Provision of Data

(71) Applicant: Ran Achiron, Adi (IL)

(72) Inventor: Ran Achiron, Adi (IL)

(21) Appl. No.: 14/684,458

(22) Filed: Apr. 13, 2015

(51) Int. Cl. H04W 4/02; G06Q 20/32

(52) U.S. Cl. CPC H04W 4/02; G06Q 20/32

(57) ABSTRACT

A smartphone App that enables users to send requests for information regarding specific sites; whereby the App identifies the geographical location of the requested site and sends the request for information to other App users who are in the vicinity of the requested site. The App may include a payment system that enables to pay for the requested information; whereby the payment system changes the requesting user and credits the user providing information as per the request for information.

### TECHNICAL FIELD

The present invention refers to a system that can be a smartphone application and/or that can be installed on any kind of computer (hereinafter “the App”) and enables the user to send a request for information regarding a specific site whereby the App sends said request to users who are located in the vicinity of said site. Any user who is in the vicinity of the site and who receives the request can supply the requested information and the App enables that user to send said information to the user who originated the request.

### BACKGROUND ART

There are many instances in which a person from the general public wishes to obtain information regarding a certain site. For instance, a person may be interested in a photo of a specific building on a specific street in a specific city, or of a specific structure, or beach, and so on and so forth. Sometimes, a person is interested in a photo of a specific site taken in real time or at a specific time of the day or the year. Thus, for instance, a person may wish to receive a photo of the Eiffel Tower in the summer at sunset. Other times a person may be interested in information about real-time events taking place at a specific location. For instance, a person may want to know whether there is an available table at a specific restaurant, whether a sports event taking place in a specific place has begun or had ended, whether or not there are jellyfish on a specific beach in California, or whether it is currently raining on a specific street in New York City. The problem arises when the person requiring the information is at a distance from the site or even in a different country or state. The present invention describes a smartphone application that offers a good and effective response to the aforementioned needs.

### DESCRIPTION OF THE DRAWINGS

The intention of the drawing attached to the application is not to limit the scope of the invention and its application.

The drawing is intended only to illustrate the invention and it constitutes only one of its many possible implementations.

FIG. 1 presents a schematic diagram of the internet communication between two smartphone devices (10) (20) and the servers (100).

### THE INVENTION

Methods, systems, computer programs, and smartphone applications for the transmission of information, texts, photos, and messages have been known to the public for a number of years already. Applications that include the possibility of making payments are also known to the general public, and are certainly known to experts in the area. Therefore, we will not elaborate in the present application on the technical structure of the smartphone application (hereinafter referred to as “the App”, subject of the present patent application, beyond that which is required by any expert in the area in order to gain a general understanding of the App.

The main objective of the present patent application is to describe an App that is designed for smartphones and a variety of telephone devices, laptops and tabletop computers with internet connection (hereinafter referred to collectively “Smartphones”). The App enables users to send requests for online information regarding specific sites and to focus their requests, such users may require that the information provided meets several criteria. For example, if the requester is interested in a photo of a specific site, he or she can specify the time of day the photo should be taken, the angle at which it should be taken, and so on (hereinafter referred to as “the Request for Information”, or “RFI”). The App can also include a payment system that enables users to pay other users for providing the requested information.

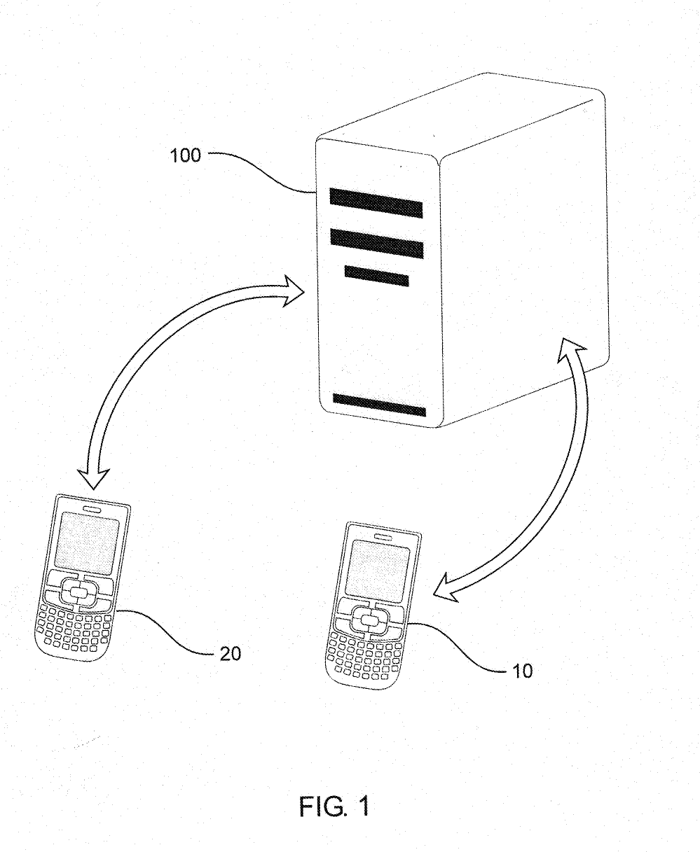

The App and the computer program that runs it, operate using Internet servers (100). FIG. 1 presents a schematic diagram of the communications setup between a Smartphone (10) of one user and the Smartphone (20) of another user who is in the vicinity of the requested site, whereby such communications take place via the server (100) on which the App runs. The App supports communications with servers (100) that transmit communications, via the internet, to and from users' Smartphones (10) (20) on which the App is installed.

The App, subject of the present patent application, includes the option of sending an RFI regarding a specific site or location (hereinafter referred to as the Requested Site”) from the one user's Smartphone (10) to another user's Smartphone (20). The App sends the RFI to users who are in the vicinity of the Requested Site and includes, among other things, the following features:

Anyone can install the App on his or her Smartphone or access the internet site that runs the App (and thus become a “User”);

The App includes a positioning option, so that at any given moment, the App can identify the geographic location of every User (in fact, it identifies the location of the User's Smartphone). The App can also include an option that enables Users who wish to maintain their privacy to temporarily cancel the App's positioning option so that the User's location may not be identified;

Any User may use the App to compose and send an RFI regarding a specific site (hereinafter referred to as “the Requested Site”). Such User is referred to as “the Requesting User”;

The system identifies the geographic location of the Requested Site and sends the RFI to Users that are, at that moment, in the vicinity of the Requested Site. Such Users are referred to as “Near Users”;

If the App cannot located the Requested Site mentioned by the Requesting User in the RFI, the Requesting User is sent a message that the Requested Site is unidentified and that additional information is required for its identification. For instance, if a Requesting User requests a photo of Annisa restaurant in New York City, the App can identify its location since this restaurant is geographically identified in the App's database and/or in any other database. If, however, a Requesting User requests a photo of the Round Table restaurant in New York City, it is possible that the App does not recognize this restaurant and then the Requesting User will have to add details, such as the restaurant's address, and so on.

As mentioned, the App sends the RFI regarding the Requested Site to Near Users and, if the RFI was for a photo or a video, they can, at their discretion, take a photo or a video in real time of the Required Site. Alternatively, they can compose a text or voice message regarding any other information the Requesting User requested, and send it back to the Requesting User via the App;

The RFI may include several additional requirements For example, if the request is for a photo, the RFI may include requirements such as the time the photo should be taken (day, night, sunrise, sunset), the time of year (winter, summer, spring, fall), the photography angle, the state of the Requested Site (for instance, the Wailing Wall in Jerusalem during public prayers), as well as other parameters aimed at focusing the request (such as view from inside or outside, focus on the structure or the people, focus on the view or the sky), and so on;

The App then sends the information or photo/s sent by Near Users in response to the said RFI, to the Requesting User;

The App may include an option whereby the Requesting User may indicate that the RIF has been responded to in a satisfactory manner. Thus, Near Users may see an indication beside the RFI that indicates whether the request is “open” and the Requesting User still wishes to receive said information, or whether the request is “closed”, i.e. the Requesting User has already received the required information;

The App may also include an option whereby the Requesting User may rate the information received in response to the RFI he or she sent according to the quality of information or of the photo and its compliance with the requirements specified in the original RFI;

The App also include an option of sending information and/or photos directly from the App's database to the Requesting User should the database contain information or a photo that meet the requirements of said RFI;

The App may include an option whereby other Near Users may request and receive the information or photos or videos sent by a Near User in response to said RFI;

The system may attribute given sites with a “demand index” or rate given sites according to the demand they conjure (i.e. according to the number of requests that refer to a given site). If, for example, a User searches the App's website for a particular place on Rue Saint-Honeré in Paris, the App will not only locate and display the search results for the User's search according to the specified RFI terms but also will suggest places in the same area according to the demand index. In other words, the App will first display sites with a high demand index.

The system may include an option according to which the Requesting User may offer payment in return for the requested information or photo; in such case the App will also include a payment system that enables payment to be made among Users via the App operator. If a Near User has sent information or a photo in response to an RFI that included an offer for payment in return for the requested information, the system will charge the account of the Requesting User and credit the account of the Near User who responded to the request.

The App is equipped with a database that identifies the geographic location of famous sites, such as the Big Ben in London, the Taj Mahal, various public buildings, restaurants, museums and a variety of sites and places. The App is also equipped with a database of the information and photos that have been sent by Users in general (not necessarily in response to RFI).

Communications between Users and the server: A Requesting User (10) sends a Request for Information that is received by the server (100). The system identifies the geographic location of the Requested Site and locates and sends the RFI to Near Users, who are Users that are in the vicinity of the Requested Site at that specific time. Any Near User may take a photo and send it in response to the request for a photo, and the photo is then sent via the server to the Requesting User, who can in turn indicate that that photo meets the RFI requirements (closed request) or not (open request). In the case of a request for general information, i.e. not a photo any Near User may send a text or voice message in response to the RFI. If payment is offered in return for such information, the App charges the Requesting User's account and credits the account of the User who sent the information in response to said RFI. The Apps' payment system can be any payment system that is currently available and/or that will be available in the future, and is used to make payments using Smartphones.

This patent offers a response in a wide variety of scenarios: a person who wishes to receive an online photo of a specific site and is in immediate need of the photo; a person who wants to know if a table is available at a given restaurant or if it is crowded; a person who wishes to know whether there is available seating or space; a person who wishes to know the atmosphere of a specific venue; a person who wishes to know whether or not a demonstration is taking place in a specific square; a person who wants to know whether a given event at a given location has begun or has ended; a person who wishes to know whether or not a certain office has reception hours at the moment; and so on and so forth kinds of information in a variety of areas and for a huge variety of sites, At present, such people have no way of receiving a response to their questions and needs. The App, subject of the present patent application, offers a good, efficient and fast response to such needs as described above, particularly since it connects any App User with a large public of other App Users who are in the vicinity of the Requested Site (i.e. Near Users) with whom the Requesting User is not familiar and who are not in his or her contact list. No App is currently available that creates a similar online connection between such anonymous people based on the geographical location of the subject of the RFI (the Requested Site).

What is claimed is:

1. A smartphone App that enables a Requesting User to send a Request for Information (RFI) about a Requested Site wherein said App identifies a geographic location of said Requested Site and sends the RFI to Near Users who are in a vicinity of said Requested Site.

2. The App mentioned in Claim No. 1 wherein said App also includes a payment system that enables to pay for requested information; wherein the payment system charges said Requesting User and credits said Near User who provided information as per the RFI.
